(19) United States
(12) Patent Application Publication
(10) Pub. No.: US 2002/0120612 A1
(43) Pub. Date: Aug. 29, 2002

(54) Document management system, document management method, and computer-readable storage medium including the same

(76) Inventor: Masahiro Ichihara, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/079,422

(22) Filed: Feb. 22, 2002

(30) Foreign Application Priority Data
Feb. 28, 2001 (JP) 2001-054776

(51) Int. Cl. G06F 7/00

(52) U.S. Cl. 707/1

(57) ABSTRACT

A document management system manages a plurality of registered documents in a database, each document having a number of sections. The document management system includes a document association object which links a reference-source document to a referenced-material document in the database. A management unit generates property data of the document association object, the property data including a first identifier indicating a section of the reference-source document and a second identifier indicating a section of the referenced-material document, wherein the property data is provided to recognize a particular relation that links the reference-source document section to the referenced-material document section.

### BACKGROUND OF THE INVENTION

1. Field of The Invention

The present invention relates to a document management system, a document management method and a computer-readable storage medium including the same. More particularly, the present invention relates to a document management system having a document association management function for making reference to a document management database, and relates to a document management method and a computer-readable storage medium having the document association management function.

2. Description of The Related Art

Conventionally, document management systems or methods generally use a document-to-document relation between respective documents. Specifically, in such conventional systems and methods, one document and another document are linked together by a document-to-document relation when the two documents have a relation between reference-source document and referenced-material document.

Japanese Laid-Open Patent Application No. 07-146870 discloses a document filing system which provides document or page relations for document management. However, the document or page relations used by the above-mentioned conventional system are not adequate for providing a refined relation between reference-source document and referenced-material document having the orientation to make reference from one document to another document. In other words, the above-mentioned system provides a document-to-document relation but it does not provide a refined relation between reference-source document and referenced-material document. It is difficult to provide an efficient tool for making reference to a particular portion of the relevant document.

Furthermore, Japanese Laid-Open Patent Application No. 05-225247 discloses a method for displaying an inter-document structure by extracting relations between plural documents through keyword searching. Japanese Laid-Open Patent Application No. 09-062658 discloses an inter-document link processing system which creates links between documents by managing the use history of respective users. Japanese Laid-Open Patent Application No. 09-081592 discloses a document management device which assigns a document class, a keyword and a keyword class to each of plural documents in order for document management. Japanese Laid-Open Patent Application No. 09-330312 discloses a document management system in which referenced document attribute information concerning a referenced document is stored when storing a source document, and the stored information is taken out for making reference thereto when the source document is opened subsequently.

However, it is difficult for the above-mentioned conventional methods to make reference to a particular portion of the relevant document since they use the document-to-document relation and the accuracy of relevance between documents is too coarse to specify the particular portion of the relevant document.

When there is a demand for document management using a function of management of sections and versions of each document, the above-mentioned conventional methods do not provide any specification about the sections or versions of each document, and the document-to-document relation will become ambiguous for that purpose.

Generally, each of documents, either reference-source document or referenced-material document, can be classified into a specific one of versions of the document or a specific one of sections of the document. However, when the document is updated and the version is changed to a new version, the document-to-document relation used by the conventional methods is still related to the old edition. In such cases, the document management provided by the conventional method is inconvenience for the users.

### SUMMARY OF THE INVENTION

An object of the present invention is to provide an improved document management system in which the above-described problems are eliminated.

Another object of the present invention is to provide a document management system that improves the efficiency of document management by providing refined relations between reference-source documents and referenced-material documents having the orientation to make reference from the reference source to the referenced material.

Another object of the present invention is to provide a document management method having a document association management function that improves the efficiency of document management by providing refined relations between reference-source documents and referenced-material documents having the orientation to make reference from the reference source to the referenced material.

Another object of the present invention is to provide a computer-readable storage medium having a document association management function that improves the efficiency of document management by providing refined relations between reference-source documents and referenced-material documents having the orientation to make reference from the reference source to the referenced material.

The above-mentioned objects of the present invention are achieved by a document management system which manages a plurality of registered documents in a database, each document having a number of sections, the system comprising: a document association object which links a reference-source document to a referenced-material document in the database; and a management unit which generates property data of the document association object, the property data including a first identifier indicating a section of the reference-source document and a second identifier indicating a section of the referenced-material document, wherein the property data of the document association object is provided to recognize a particular relation that links the reference-source document section to the referenced-material document section.

The above-mentioned objects of the present invention are achieved by a document management method managing a plurality of registered documents in a database, each document having a number of sections, the method comprising the steps of: providing a document association object linking a reference-source document to a referenced-material document in the database; and generating property data of the document association object, the property data including a first identifier indicating a section of the reference-source document, a second identifier indicating a section of the referenced-material document, a third identifier indicating a version of the reference-source document and a fourth identifier indicating a version of the referenced-material document, wherein the property data of the document association object is provided to recognize a particular relation that links the reference-source document version and section to the referenced-material document version and section.

The above-mentioned objects of the present invention are achieved by a computer-readable storage medium storing program code causing a processor to perform a document management method managing a plurality of registered documents in a database, each document having a number of sections, the method comprising: providing a document association object linking a reference-source document to a referenced-material document in the database; and generating property data of the document association object, the property data including a first identifier indicating a section of the reference-source document and a second identifier indicating a section of the referenced-material document, wherein the property data of the document association object is provided to recognize a particular relation that links the reference-source document section to the referenced-material document section.

In the document management system, the document management method and the computer-readable storage medium of the present invention, it is possible to provide refined relations between the reference-source document and the referenced-material document having the orientation to make reference. The refined relations provided by the present invention cover the section-to-section relations or the version-to-version relations which are finer than the document-to-document relations provided by the conventional system. Accordingly, the present invention is effective in making more exact reference from the reference-source document to the referenced-material document in the document management database. Hence, the document management system, the document management method and the computer-readable storage medium of the present invention make it possible to increase the efficiency of document management.

Moreover, the document management system, the document management method and the computer-readable storage medium of the present invention allow the operator to specify a particular version or a particular section of a document of concern when making reference from the reference-source document to the referenced-material document. Accordingly, the present invention is effective in providing more exact document associations between the reference-source document and the referenced-material document in the document management database.

Furthermore, even when there is a renewal of version of a relevant document, the document management system, the document management method and the computer-readable storage medium of the present invention can automatically update the document association object linked to the relevant document. Accordingly, the present invention makes it possible to easily and efficiently carry out the document management.

### BRIEF DESCRIPTION OF THE DRAWINGS

Other objects, features and advantages of the present invention will be apparent from the following detailed description when read in conjunction with the accompanying drawings.

FIG. 1 is a block diagram of one preferred embodiment of the document management system according to the present invention.

FIG. 2 is a flowchart for explaining a first preferred embodiment of a document association management procedure executed by the document management system of the present invention.

FIG. 3 is a flowchart for explaining a second preferred embodiment of the document association management procedure executed by the document management system of the present invention.

FIG. 4A is a flowchart for explaining a third preferred embodiment of the document association management procedure executed by the document management system of the present invention when a document of concern is updated.

FIG. 4B is a flowchart for explaining a fourth preferred embodiment of the document association management procedure executed by the document management system of the present invention when a document of concern is deleted.

FIG. 5A is a diagram for explaining operation of the document association management procedure in FIG. 2.

FIG. 5B is a diagram showing property data of a document association object used by the document association management procedure in FIG. 2.

FIG. 6A is a diagram for explaining operation of the document association management procedure in FIG. 3.

FIG. 6B is a diagram showing property data of a document association object used by the document association management procedure in FIG. 3.

FIG. 7 is a diagram for explaining operation of the document association management procedure in FIG. 4A when the document of concern is updated.

FIG. 8 is a diagram for explaining operation of the document association management procedure in FIG. 4B when the document of concern is deleted.

### DETAILED DESCRIPTION OF PREFERRED EMBODIMENTS

A description will now be provided of preferred embodiments of the present invention with reference to the accompanying drawings.

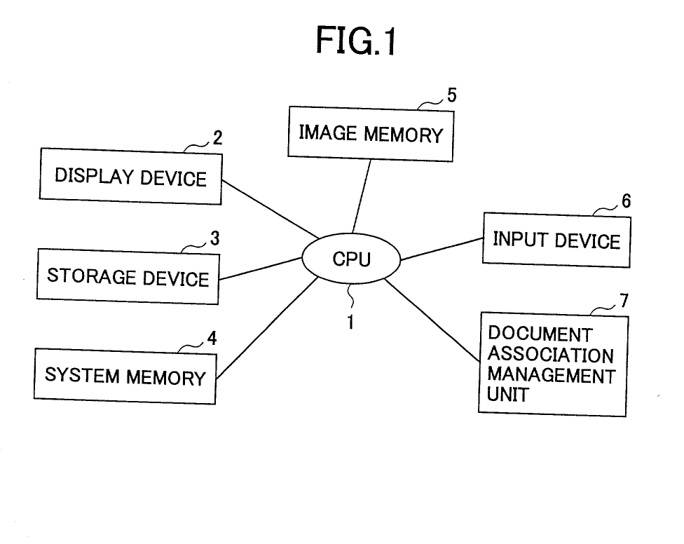

FIG. 1 shows one preferred embodiment of the document management system according to the present invention.

As shown in FIG. 1, the document management system of the present embodiment is constituted by a server computer or a client computer that is connected to a communication network (not shown). The document management system of the present embodiment generally includes a CPU (central processing unit) 1, a display device 2, a storage device 3, a system memory 4, an image memory 5, an input device 6, and a document association management unit 7.

The CPU 1 controls the entire document management system. Under the control of the CPU 1, the document association management unit 7 performs a document association management procedure in accordance with program code stored in the storage device 3, which will be described later. The display device 2 displays an image of a registered document that is read from the image memory 5, as well as an operational message that is given during execution of the document association management procedure. The storage device 3 stores the program, the contents of registered documents, attribute information of the registered documents and others. The storage device 3 in the present embodiment is a magnetic disk drive or an optical disk drive that provides a mass storage capacity.

The system memory 4 provides a working memory area to which the program from the storage device 3 is loaded. The image memory 5 stores respective image data of the registered documents. A document management database, including the image data of the registered documents, is provided in, for example, the image memory 5. Alternatively, the document management database may be provided in the storage device 3. The input device 6 includes a pointing device such as a mouse, and a keyboard. The input device 6 supplies a command or operational data, input by the operator, to the CPU 1.

In the present embodiment, the document association management unit 7 is constituted by the CPU 1 which performs the document association management procedure in accordance with the program code stored in the storage device 3. In other words, the program code causes the CPU 1 to perform the document association management procedure, which constitutes the document association management unit 7 in the present embodiment. The computer-readable storage medium of the present invention is, for example, a magnetic disk or an optical disk which stores the program code of the document association management procedure. Initially, such a storage medium storing the program code is set in the storage device 3 for installation of the software, so that the program code is installed into the document management system of the present embodiment.

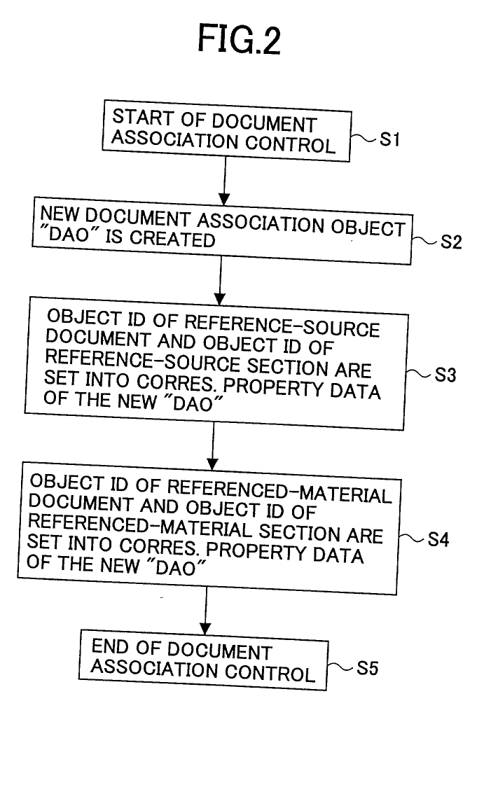

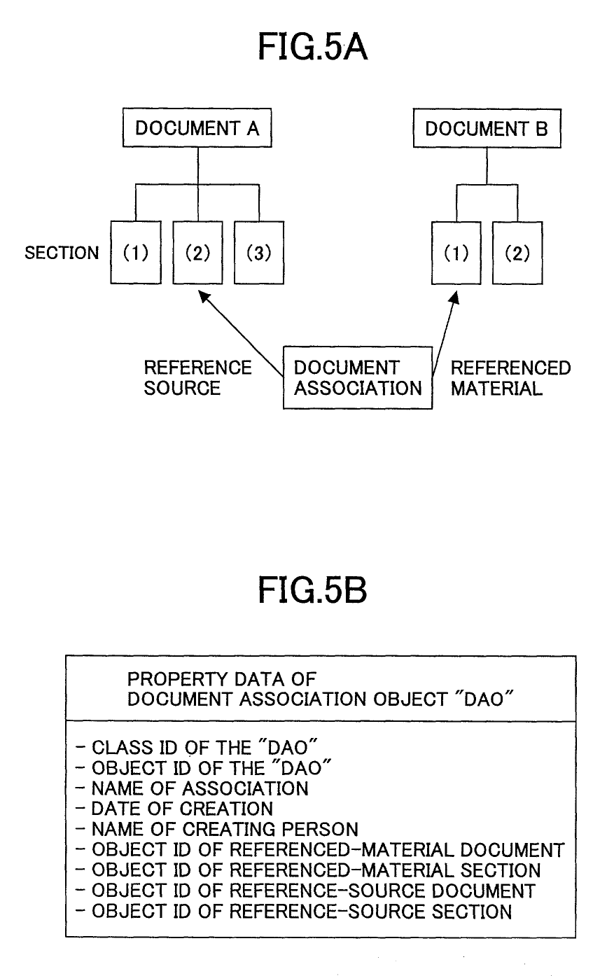

Next, a description will be given of a first preferred embodiment of the document association management procedure executed by the document management system of the present invention, with reference to FIG. 2, FIG. 5A and FIG. 5B.

Hereinafter, it is supposed that each document, which is registered in the document management system of the present invention, consists of a number of sections, each section containing one or a plurality of phases or sentences. The term “section” means a separate part of a document. Incidentally, a certain section, included in a registered document, may consist of a number of subsections.

FIG. 2 is a flowchart for explaining the first preferred embodiment of the document association management procedure. FIG. 5A shows operation of the document association management procedure in FIG. 2. FIG. 5B shows property data of a document association object used by the document association management procedure in FIG. 2.

As described above, the document association management unit 7 is constituted by the CPU 1 of the document management system which performs the document association management procedure in FIG. 2 in accordance with the program code. Hereinafter, the CPU 1 will be called the processor for the sake of convenience.

In order to provide refined relations between reference-source documents and referenced-material documents having the orientation to make reference from the reference source to the referenced material, the document association management unit 7 of this embodiment creates a new document association object (DAO) containing property data every time a relation (which is roughly called a document association) between a reference-source section and a referenced-material section is provided to the document management system.

In the example shown in FIG. 5A, it is assumed that document A consists of three sections (1), (2) and (3), document B consists of two sections (1) and (2), and a document association between the second section of document A and the first section of document B is provided. In this example, the document association management unit 7 of the present embodiment creates a new document association object in order to recognize the above-mentioned document association.

As shown in FIG. 5B, the property data of the document association object (DAO) in this embodiment includes a class ID of the DAO itself, an object ID of the DAO itself, a name of the association, a date of the creation, a name of the creating person, an object ID of a reference-source document, an object ID of a reference-source section, an object ID of a referenced-material document, and an object ID of a referenced-material section.

The above-described property data of the document association object (DAO) is provided in the document management system of the present embodiment to recognize a particular document association that links the reference-source section of one document to the referenced-material section of another document.

More specifically, in the example of FIG. 5A, document A and the 2nd section of document A are respectively set up as the reference-source document and the reference-source section in the document association object (DAO), and document B and the 1st section of document B are respectively set up as the referenced-material document and the referenced-material section in the document association object (DAO).

As shown in FIG. 2, the program code causes the processor to start the document association control (S1). After the step S1 is performed, the program code causes the processor to create a new document association object “DAO” (S2). At this time, a class ID of the DAO, an object ID of the DAO, a name of the association, a date of the creation and a name of the creating person, among the property data of the DAO are determined in response to the input data given by the operator from the input device 6. The new DAO, which is now being created, must be provided to link a reference-source section of one document to a referenced-material section of another document. To attain the above-described document association function, it is necessary for the DAO to contain exact property data as shown in FIG. 5B.

After the step S2 is performed, the program code causes the processor to set an object ID of a reference-source document and an object ID of a reference-source section into the corresponding property data of the new DAO (S3). In the present embodiment, the reference-source document and the reference-source section are specified by the operator from the input device 6 while viewing the display device 2. In response to the input data of the operator, the document association management unit 7 automatically assigns an object identifier (for example, a serial number) to each of the document and the section specified by the operator.

After the step S3 is performed, the program code causes the processor to set an object ID of a referenced-material document and an object ID of a referenced-material section into the corresponding property data of the new DAO (S4). In the present embodiment, the referenced-material document and the referenced-material section are specified by the operator from the input device 6 while viewing the display device 2. In response to the input data of the operator, the document association management unit 7 automatically assigns an object identifier (for example, a serial number) to each of the document and the section specified by the operator.

After the step S4 is performed, the program code causes the processor to store all the property data of the new document association object, and the document association management procedure of FIG. 2 ends (S5).

Accordingly, the document management system of the present embodiment is effective in improving the efficiency of document management by providing refined relations between reference-source documents and referenced-material documents having the orientation to make reference from the reference source to the referenced material.

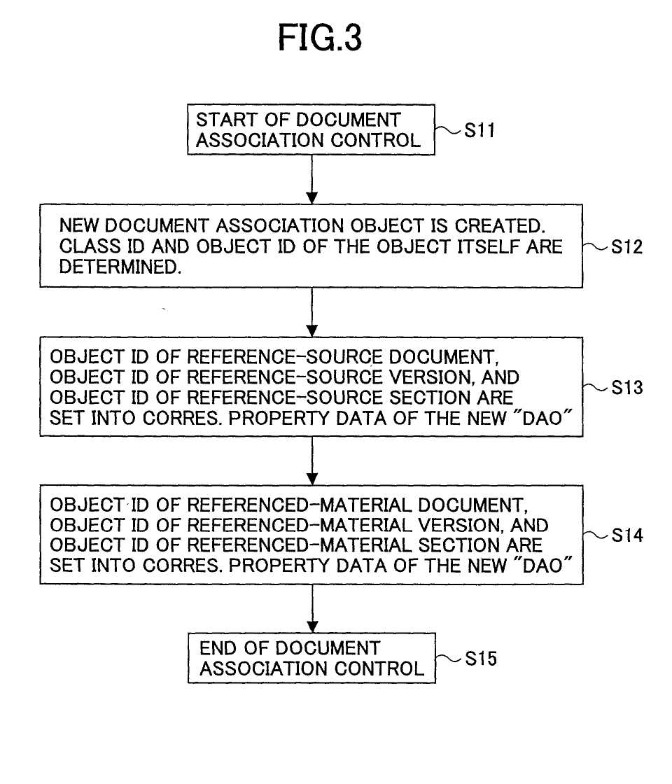

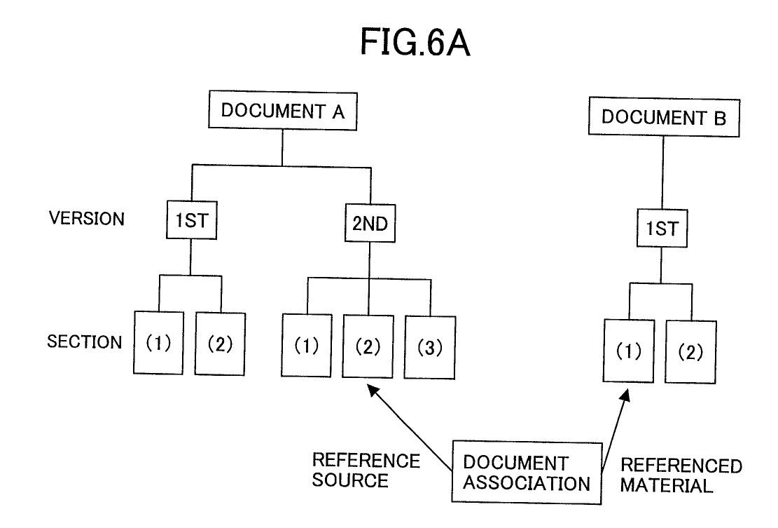

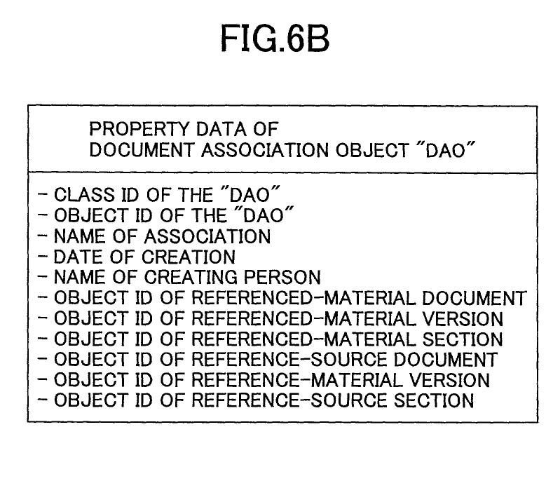

Next, a description will be given of a second preferred embodiment of the document association management procedure executed by the document management system of the present invention, with reference to FIG. 3, FIG. 6A and FIG. 6B.

FIG. 3 is a flowchart for explaining the second preferred embodiment of the document association management procedure. FIG. 6A shows operation of the document association management procedure in FIG. 3. FIG. 6B shows property data of a document association object used by the document association management procedure in FIG. 3.

In the present embodiment, the document management system is provided with a more refined document association function (or version-to-version linking function) in addition to the section-to-section linking function as in the previous embodiment of FIG. 2.

In the example shown in FIG. 6A, it is assumed that document A consists of two versions: first version and second version, the first version consisting of two sections (1) and (2), the second version consisting of three sections (1), (2) and (3). It is also assumed that document B consists of only one version: first version, the first version consisting of two sections (1) and (2). Moreover, it is assumed that a document association between the second section of the second version of document A and the first section of the first version of document B is provided as indicated by the arrows in FIG. 6A. In this example, the document association management unit 7 creates a new document association object (DAO) in order to recognize the above-mentioned document association.

As shown in FIG. 6B, the property data of the document association object (DAO) in this embodiment includes a class ID of the DAO itself, an object ID of the DAO itself, a name of the association, a date of the creation, a name of the creating person, an object ID of a reference-source document, an object ID of a reference-source version, an object ID of a reference-source section, an object ID of a referenced-material document, an object ID of a referenced-material version, and an object ID of a referenced-material section.

The above-described property data of the document association object (DAO) is provided in the document management system of the present embodiment to recognize a particular document association that links the reference-source section and version of one document to the referenced-material section and version of another document.

More specifically, in the example of FIG. 6A, document A, the 2nd version of document A and the 2nd section of the 2nd version of document A are respectively set up as the reference-source document, the reference-source version and the reference-source section in the document association object (DAO), while document B, the 1st version of document B and the 1st section of the 1st version of document B are respectively set up as the referenced-material document, the referenced-material version and the referenced-material section in the document association object (DAO).

As shown in FIG. 3, the program code causes the processor to start the document association control (S11). After the step S11 is performed, the program code causes the processor to create a new document association object “DAO” (S12). At this time, a class ID of the DAO, an object ID of the DAO, a name of the association, a date of the creation and a name of the creating person, among the property data of the DAO are determined in response to the input data given by the operator from the input device 6. The new DAO, which is now being created, must be provided to link a reference-source section and version of one document to a referenced-material section and version of another document. To attain the above-described document association function, it is necessary for the DAO to contain exact property data as shown in FIG. 6B.

After the step S12 is performed, the program code causes the processor to set an object ID of a reference-source document, an object ID of a reference-source version and an object ID of a reference-source section into the corresponding property data of the new DAO (S13). In the present embodiment, the reference-source document, the reference-source version and the reference-source section are specified by the operator from the input device 6 while viewing the display device 2. In response to the input data of the operator, the document association management unit 7 automatically assigns an object identifier (for example, a serial number) to each of the document, the version and the section specified by the operator.

After the step S13 is performed, the program code causes the processor to set an object ID of a referenced-material document, an object ID of a referenced-material version and an object ID of a referenced-material section into the corresponding property data of the new DAO (S14). In the present embodiment, the referenced-material document, the referenced-material version and the referenced-material section are specified by the operator from the input device 6 while viewing the display device 2. In response to the input data of the operator, the document association management unit 7 automatically assigns an object identifier (for example, a serial number) to each of the document, the version and the section specified by the operator.

After the step S14 is performed, the program code causes the processor to store all the property data of the new document association object (DAO), and the document association management procedure of FIG. 3 ends (S15).

Accordingly, the document management system of the present embodiment is effective in improving the efficiency of document management by providing more refined relations between reference-source documents and referenced-material documents having the orientation to make reference from the reference source to the referenced material.

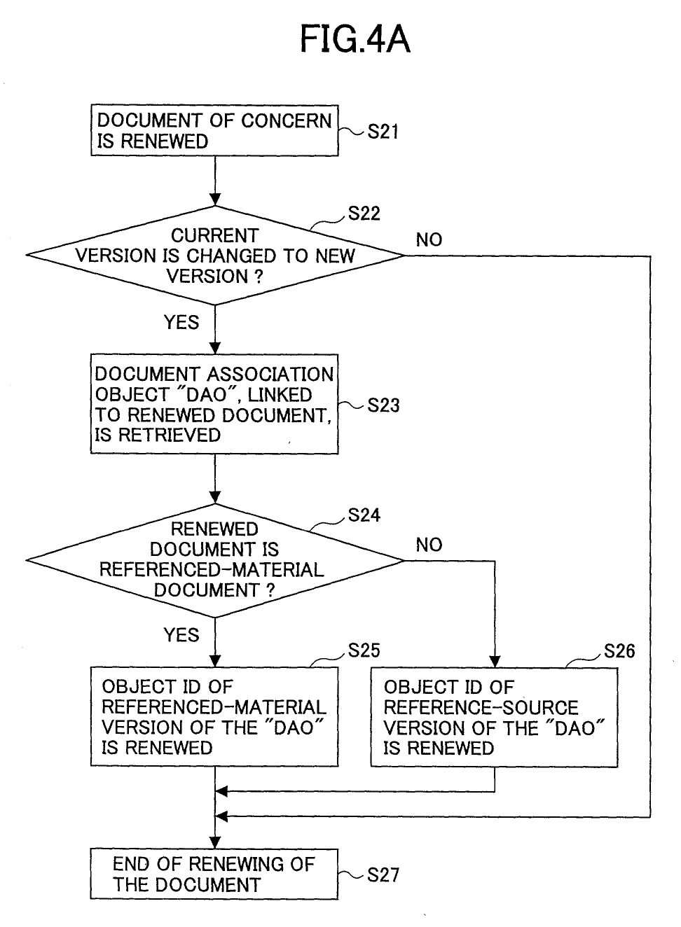

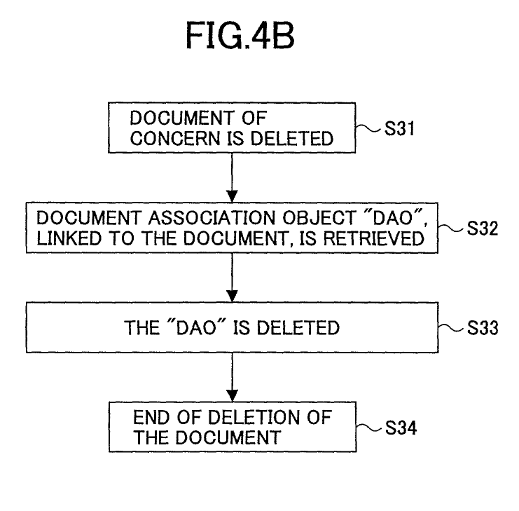

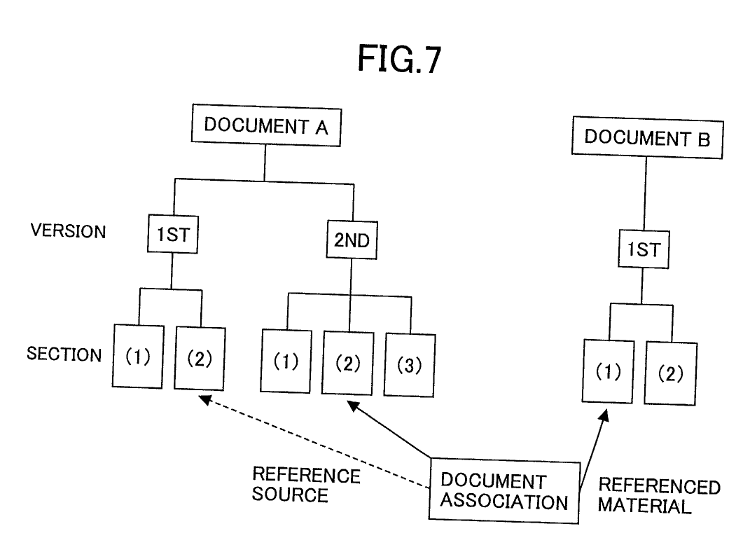

Next, a description will be given of a third preferred embodiment of the document association management procedure executed by the document management system of the present invention, with reference to FIG. 4A and FIG. 7.

FIG. 4A is a flowchart for explaining the third preferred embodiment of the document association management procedure executed when a document of concern is updated. FIG. 7 shows operation of the document association management procedure in FIG. 4A when the document of concern is updated.

In the present embodiment, the document management system is provided with a document association updating function that is responsive to an update of a document of concern.

In the example shown in FIG. 7, it is assumed that document A previously consists of only one version: first version, the first version consisting of two sections (1) and (2), and an update of document A takes place, and then document A currently consists of two versions: first version and second version, the first version consisting of the two sections (1) and (2), and the second version consisting of three sections (1), (2) and (3). Namely, the 3rd section (3) is newly added in the second version of document A. It is also assumed that document B consists of only one version: first version, the first version consisting of two sections (1) and (2), and there is no update of document B. Moreover, it is assumed that a document association between the second section of the first version of document A and the first section of the first version of document B is previously provided as indicated by the dotted-line arrow in FIG. 7. In this example, the document association management unit 7 updates the existing document association object (DAO) in order to correctly recognize the above-mentioned document association.

For the sake of convenience of description, the document association object (DAO) in this embodiment contains the property data that is the same as that shown in FIG. 6B.

When an update of a document of concern takes place, the document management system of the present embodiment updates the property data of the document association object (DAO) linked to the document of concern, in order to correctly recognize the existing document association after the update of the document of concern.

As shown in FIG. 4A, the program code causes the processor to detect that a document of concern (which is also called the relevant document) is renewed (S21). After the step S21 is performed, the program code causes the processor to determines whether the current version of the document of concern is changed to a new version (S22).

When the result at the step S22 is affirmative, the control of the processor is transferred to step S23. Otherwise the document association management procedure of FIG. 4A ends. In the step S23, the program code causes the processor to retrieve the document association object (DAO) linked to the renewed document (the relevant document), in the document management database.

After the step S23 is performed, the program code causes the processor to determine whether the renewed document is a referenced-material document, based on the property data of the existing DAO (S24). When the result at the step S24 is affirmative, the renewed document is a referenced-material document. In this case, the program code causes the processor to renew the object ID of the referenced-material version in the existing DAO to a new one that matches with the new version of the relevant document (S25).

On the other hand, when the result at the step S24 is negative, the renewed document is a reference-source document. In this case, the program code causes the processor to renew the object ID of the reference-source version in the existing DAO to a new one that matches with the new version of the relevant document (S26).

After the step S25 or S26 is performed, the program code causes the processor to store all the property data of the document association object (DAO) including the renewed data, and the document association management procedure of FIG. 4A ends (S27).

In the example shown in FIG. 7, the document association management unit 7 updates the existing document association object (DAO) through the performance of the document association management procedure of FIG. 4A, so that the new DAO links the second section of the second version of document A (the renewed document) to the first section of the first version of document B as indicated by the solid-line arrow in FIG. 7.

Accordingly, the document management system, the document management method and the computer-readable storage medium of the present embodiment can automatically update the document association object linked to the relevant document when there is an update of the relevant document. Thus, the present invention makes it possible to easily and efficiently carry out the document management.

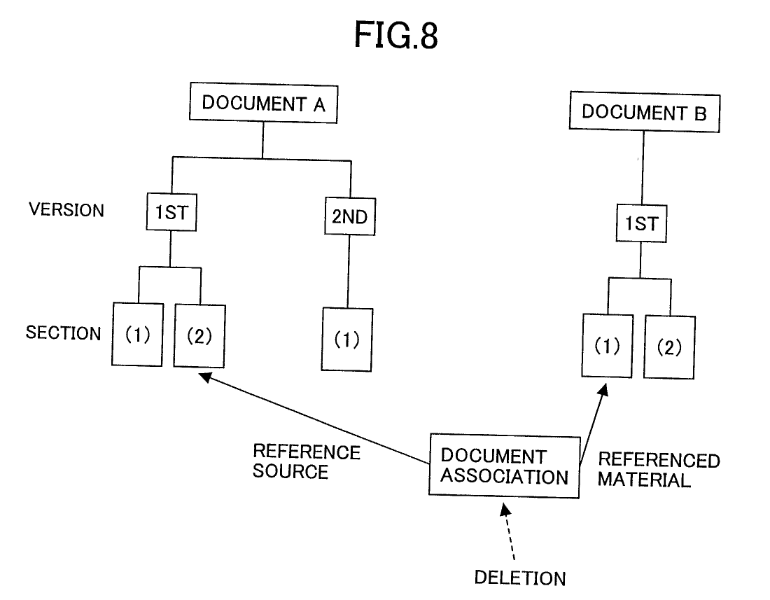

Next, a description will be given of a fourth preferred embodiment of the document association management procedure executed by the document management system of the present invention, with reference to FIG. 4B and FIG. 8.

FIG. 4B is a flowchart for explaining the fourth preferred embodiment of the document association management procedure executed when a document of concern is deleted. FIG. 8 shows operation of the document association management procedure in FIG. 4B when the document of concern is deleted.

In the present embodiment, the document management system is provided with a document association deleting function that is responsive to a deletion of a document of concern.

In the example shown in FIG. 8, it is assumed that document A previously consists of only one version: first version, the first version consisting of two sections (1) and (2), and an update of document A takes place so that the second section of the first version is deleted, and then document A currently consists of two versions: first version and second version, the first version consisting of the two sections (1) and (2), and the second version consisting of only one section (1). Namely, the second section (2) of the first version is deleted and there is no second section in the second version of document A. It is also assumed that document B consists of only one version: first version, the first version consisting of two sections (1) and (2), and there is no update of document B. Moreover, it is assumed that a document association between the second section of the first version of document A and the first section of the first version of document B is previously provided as indicated by the solid-line arrow in FIG. 8. In this example, the document association management unit 7 deletes the existing document association object (DAO) in response to the deletion of the relevant document.

For the sake of convenience of description, the document association object (DAO) in this embodiment contains the property data that is the same as that shown in FIG. 6B.

As shown in FIG. 4B, the program code causes the processor to detect that there is a deletion of a document of concern (which is also called the relevant document) (S31). After the step S31 is performed, the program code causes the processor to retrieve the existing document association object (DAO) linked to the renewed document, in the document management database (S32).

After the step S32 is performed, the program code causes the processor to delete the existing document association object DAO (linked to the renewed document) from the database (S33).

After the step S33 is performed, the program code causes the processor to terminate the document association management procedure of FIG. 4B ends (S34).

In the example shown in FIG. 8, the document association management unit 7 deletes the existing document association object (DAO), as indicated by the dotted line in FIG. 8, through the performance of the document association management procedure of FIG. 4B.

Accordingly, the document management system, the document management method and the computer-readable storage medium of the present embodiment can automatically delete the document association object linked to the relevant document when there is a deletion of the relevant document. Thus, the present invention makes it possible to easily and efficiently carry out the document management.

Furthermore, according to the document association management procedure of the present embodiment, when a referenced-material document or a reference-source document is deleted from the database, the document association object (linked to the document of concern) itself is deleted.

The present invention is not limited to the above-described embodiments, and variations and modifications may be made without departing from the scope of the present invention.

Further, the present invention is based on Japanese priority application No. 2001-054776, filed on Feb. 28, 2001, the entire contents of which are hereby incorporated by reference.

What is claimed is

1. An document management system for managing a plurality of registered documents in a database, each document having a number of sections, the system comprising:
a document association object linking a reference-source document to a referenced-material document in the database; and
a management unit generating property data of the document association object, the property data including a first identifier indicating a section of the reference-source document and a second identifier indicating a section of the referenced-material document, wherein the property data of the document association object is provided to recognize a particular relation that links the reference-source document section to the referenced-material document section.

2. The document management system according to claim 1, wherein the management unit is configured to generate the property data of the document association object, the property data including the first identifier, the second identifier, a third identifier indicating a version of the reference-source document and a fourth identifier indicating a version of the referenced-material document, and
wherein the property data of the document association object is provided to recognize a particular relation that links the reference-source document version and section to the referenced-material document version and section.

3. A document management method for managing a plurality of registered documents in a database, each document having a number of sections, the method comprising the steps of:
providing a document association object linking a reference-source document to a referenced-material document in the database; and
generating property data of the document association object, the property data including a first identifier indicating a section of the reference-source document, a second identifier indicating a section of the referenced-material document, a third identifier indicating a version of the reference-source document and a fourth identifier indicating a version of the referenced-material document,
wherein the property data of the document association object is provided to recognize a particular relation that links the reference-source document version and section to the referenced-material document version and section.

4. The document management method according to claim 3, further comprising the steps of:
detecting that a relevant document linked to the document association object is renewed to change a previous version of the relevant document to a new version; and
updating the property data of the document association object so that one of the reference-source document version and the referenced-material document version is renewed so as to match the new version of the relevant document.

5. The document management method according to claim 3, further comprising the steps of:
detecting that a section of a relevant document linked to the document association object is detected; and
deleting the document association object including the property data.

6. A computer-readable storage medium storing program code causing a processor to perform a document management method for managing a plurality of registered documents in a database, each document having a number of sections, the method comprising:
providing a document association object linking a reference-source document to a referenced-material document in the database; and
generating property data of the document association object, the property data including a first identifier indicating a section of the reference-source document and a second identifier indicating a section of the referenced-material document,
wherein the property data of the document association object is provided to recognize a particular relation that links the reference-source document section to the referenced-material document section.

7. The computer-readable storage medium according to claim 6, wherein the property data of the document association object is generated to include the first identifier, the second identifier, a third identifier indicating a version of the reference-source document and a fourth identifier indicating a version of the referenced-material document,
wherein the property data of the document association object is provided to recognize a particular relation that links the reference-source document version and section to the referenced-material document version and section.

8. The computer-readable storage medium according to claim 7, wherein the method further comprises
updating, when a relevant document, linked to the document association object, is renewed to change a previous version of the relevant document to a new version, the property data of the document association object so that one of the reference-source document version and the referenced-material document version is renewed so as to match the new version of the relevant document.
